(19) United States
(12) Patent Application Publication
(10) Pub. No.: US 2007/0171816 A1
(43) Pub. Date: Jul. 26, 2007

(54) Method and apparatus for call reroute based upon QoS

(75) Inventors: Gerald W. Pfleging, Batavia, IL (US); George Paul Wilkin, Bolingbrook, IL (US); David A. Zahn, Naperville, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/336,703

(22) Filed: Jan. 20, 2006

(51) Int. Cl. H04J 3/14

(52) U.S. Cl. 370/225

(57) ABSTRACT

A method to reroute a call with a first termination point and a second termination point based upon Quality of Service (QoS) is disclosed. The method comprises establishing a quantitative QoS threshold, establishing a first communication path through a network for a data transmission such as a call, testing the QoS of the first communication path during the call or call set up and generating a quantitative value based upon said QoS. The method further includes establishing a second communication path for the call if the quantitative value is not to the level of the quantitative QoS threshold. Finally, the method includes rerouting the call from said first communication path to the second communication path while maintaining the first termination point.

### BACKGROUND OF THE INVENTION

This invention relates to a method and apparatus for rerouting a data transmission such as a call. More particularly, this invention relates to a method and apparatus for rerouting such a transmission to a different network path based upon Quality of Service (QoS).

While the invention is particularly directed to the art of Voice over Internet Protocol (VoIP) telephony, and will be thus described with specific reference thereto, it will be appreciated that the invention may have usefulness in other fields and applications. For example, the invention may be used in other types of audio and data transmission including traditional Plain Old Telephone Service (POTS), Voice over Internet Protocol (VoIP), WiFi, WiMAX, cellular, steaming video, etc. This invention could also be useful in other types of data transfer systems.

By way of background, a VoIP network converts analog audio data to digital audio data. This digital data is then transmitted over the internet as a packet stream that represents a call. Many phone companies use VoIP to streamline networks by routing thousands of phone calls through a circuit switch and into an IP gateway. Among other functions, the gateway compresses the data and transmits the data through the network. Once the packet stream associated with a call is received by the destination gateway, the call is decompressed, reassembled and routed to a local circuit switch.

VoIP technology is quickly gaining popularity as a way to transfer voice data. Because of numerous economic and infrastructure benefits VoIP is a viable alternative to traditional telephone services. However, in order to become major competitor, VoIP technology must match the level of reliability and voice quality of the existing POTS systems.

VoIP technology is more sensitive than other forms of audio/voice transmission. As such, there are many problems associated with VoIP technology that are not factors with other telephone services. Most commonly, excessive bandwidth usage and the packets being out of order, contribute to poor voice transmission. Notably, these factors have a very minor effect on data transmission quality. Although, the average customer may not notice the reduction in quality for strict data transmission, the average customer would likely (and indeed does) notice the drop in voice quality (QoS) when these difficulties are encountered. However, when a relatively small amount of packets are lost or out of order, it can cause many noticeable problems such as jitter and latency which in turn can cause echo problems and/or dropouts. These problems render VoIP technology less desirable to the average user than traditional phone service.

Many users that demand a high level of voice quality have access to more than one telecommunications network base. Therefore, there is a need in the industry to forward calls to networks having the best opportunity to achieve high quality transmission. Furthermore, there is need for a process that can transfer these calls to the other network paths automatically with minimal end user intervention.

The present invention contemplates a new and improved method and apparatus that resolves the above-referenced difficulties and others.

### SUMMARY OF THE INVENTION

A method and apparatus for rerouting data transmissions, such as a call, to different network paths based upon QoS is provided.

In one aspect of the invention, the method includes establishing a QoS threshold, establishing a first communication path through a network for a data transmission, such as a call, testing the QoS and deriving a quantitative value from that test. If the measured QoS falls below the QoS threshold, the method further includes setting up a three port conference circuit and rerouting the data transmissions, such as a call, while maintaining at least one termination point.

In accordance with another aspect of the invention, the method further includes rerouting the data transmissions, such as a call, to a different network path.

In accordance with another aspect of the invention, the method further includes rerouting the data transmissions, such as a call, using to a different transport type.

In accordance with another aspect of the invention, the method further includes testing the availability of a third termination point and connecting the second path to that third termination point.

In accordance with another aspect of the invention, the method further includes displaying on the device associated with the third termination point a special message communicating that this is a QoS transferred call.

In accordance with another aspect of the invention, the method further includes testing the QoS of the second communication path.

In accordance with another aspect of the invention, the method further includes generating a report to a billing database and to customer service that tells why the data transmission, such as a call, was rerouted.

In accordance with another aspect of the invention, the system includes a quantitative QoS threshold, a QoS test module adapted to measure the QoS and derive a quantitative value for QoS, and a rerouting module adapted to set up at least a second communication path if said quantitative value for QoS of a first communication path is not to the level of said quantitative QoS threshold.

In accordance with another aspect of the invention, the system includes a second communication path that may or may not be in a different network than the first communication path.

In accordance with another aspect of the invention, the system includes a second communication path that is in a different transport type than said first communication path.

In accordance with another aspect of the invention, the system includes a rerouting module and a QoS testing module that are housed within a switch.

In accordance with another aspect of the invention, the system includes a means for establishing a QoS threshold, a means for establishing a first communication path through a network for a call, a means for testing the QoS and deriving a quantitative value from that test. If the QoS falls below the QoS threshold, a means for setting up a three port conference circuit and a means for rerouting the call while maintaining at least one termination point.

In accordance with another aspect of the invention, the system includes a means for rerouting the call to a different network path.

In accordance with another aspect of the invention, the system includes a means for rerouting the call using to a different transport type.

In accordance with another aspect of the invention, the system includes a means for testing the availability of a third termination point and a means for connecting the second path to that third termination point.

In accordance with another aspect of the invention, the system includes a means for displaying on the device associated with the third termination point a special message communicating that this is a QoS transferred call.

In accordance with another aspect of the invention, the system includes a means for testing the QoS of the second communication path.

In accordance with another aspect of the invention, the system includes a means for generating a report to a billing database and to customer service that tells why the call was rerouted.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates a portion of the communications network including an IP network, a network provider, a switch, a cellular line, a cellular telephone, a VoIP line, a VoIP telephone, a traditional POTS line, and a POTS telephone in accordance with the invention.

FIG. 2 is a flowchart illustrating a method according to the present invention.

FIG. 3 illustrates a switch according to an embodiment of the present invention.

### DETAILED DESCRIPTION OF THE PREFERRED EMBODIMENTS

Referring now to the drawings wherein the showings are for purposes of illustrating the preferred embodiments of the invention only and not for purposes of limiting the same.

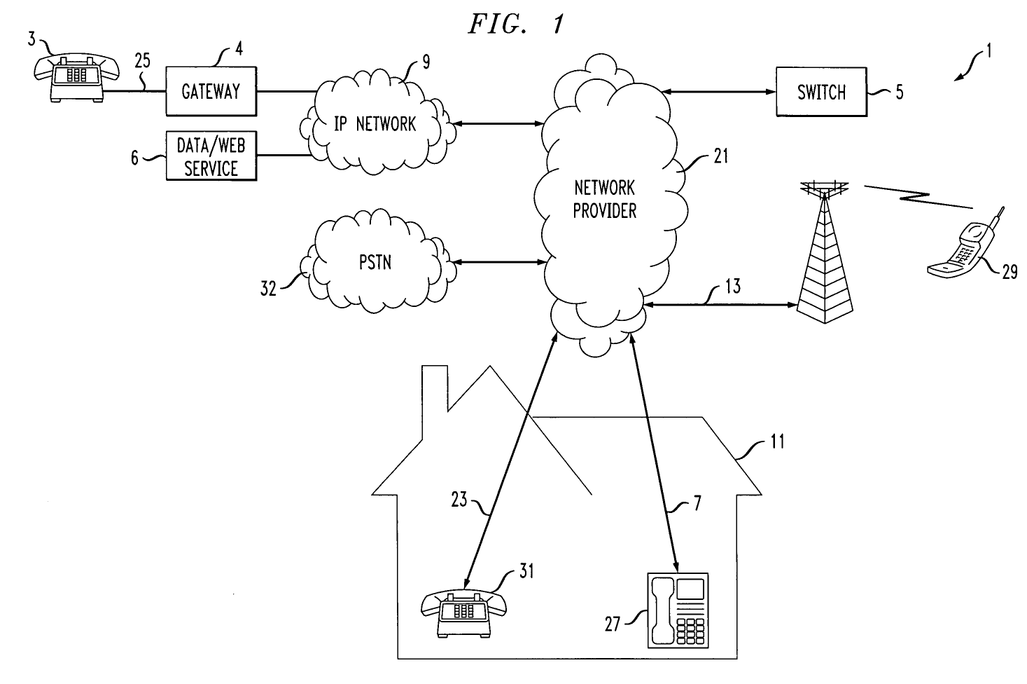

FIG. 1 provides a view of an overall system into which the presently described embodiments may be incorporated. The communications network infrastructure 1 is shown generally. The communications network infrastructure 1 includes a first termination point 3, a gateway 4, a switch 5, the data/web service 6, an IP network 9, an end user's house or customers premises 11, a mobile line 13, a mobile telephone 29, VoIP telephone 17, a VoIP line 7, a network provider 21, a Public Switch Telephone Network (PSTN) 32, a POTS line 23, and a POTS telephone 31. It should be understood that this is but one embodiment of the communications network infrastructure 1. This invention could be incorporated in a variety of communications network configurations.

As described in greater detail below, according to the presently described embodiments, a technique for rerouting a call, for example, with a first termination point 3 and a second termination point 27 is provided. It should be understood that although a voice call is the exemplary form of data transmission addressed in connection with a description. of the presently described embodiments, any type of data transmission will suffice. The method comprises establishing a quantitative QoS threshold and a first communication path 7 through a network 9, 21 for a call. The method further comprises testing the QoS of the first communication path 7 during the call, or during call setup, and generating a quantitative value based upon the QoS. The method further includes establishing a second (or possibly a third or fourth) communication path 13 for the call if the quantitative value does not meet the acceptable level of the quantitative quality of the service threshold. The method further includes rerouting the call from the first communication path 7 to the new communication path 13 while maintaining at least the first termination point 3.

In this embodiment, the first termination point 3, is the point from which the call originates. It should be appreciated, however, that it is not necessary for the call to originate from the first termination point 3. In this regard the first termination point 3 is illustrated to be a VoIP line 29 using a gateway 4 to support an existing POTS telephone; however it should be understood that the first termination point 3 could stem from a plurality of different telecommunication systems and originate from many of the point contained in the drawing. Stated another way, the first termination point 3 could extend from a VoIP device, cellular device, etc.

The data/web service 6 uses the switch 5 to connect a call from the first termination point 3 to a second termination point 27 through the IP network 9 and network provider 21 via the first communication path 7. In this embodiment, an end user is associated with the second termination point (the VoIP line) 27, the POTS telephone line 23 and the cellular line 13. The second termination point (the VoIP line) 27 and the POTS telephone line 23 are both located inside the end user's house 11. However, the POTS telephone line 23 is an analog line connect through the PSTN 32. The alternative lines 23, 13 may be in a different network path or involve using a different transport type than the VoIP line 7. However, it should be appreciated that the end user could be associated with other forms of telecommunication.

The end devices 31, 29, 27 are associated with the corresponding lines or paths 23, 13, 7. The end devices are, in many forms, the consumer premises equipment (CPE) used to communicate through the compatible line. The network provider 21 has access to the different telephone numbers associated with these lines.

In one form, customers can specify which lines or paths that they would like the network provider 21 to connect to, and in what order to attempt to connect them. Customers can also specify that these alternative lines be connected simultaneously. In this manner, more than one line path is connected at a time.

In one form, the end devices 31 and 29 display a special signal when they are receiving a QoS transferred call. This signal may be a special ring or it could display a message on the caller identification. In one form, it is displayed on the caller identification that the incoming number is the end user himself. The incoming caller identification displays that the newly established call is for the express purpose of poor QoS on the current call. Essentially, the caller identification displays some message that the incoming call was only an extension of the current call.

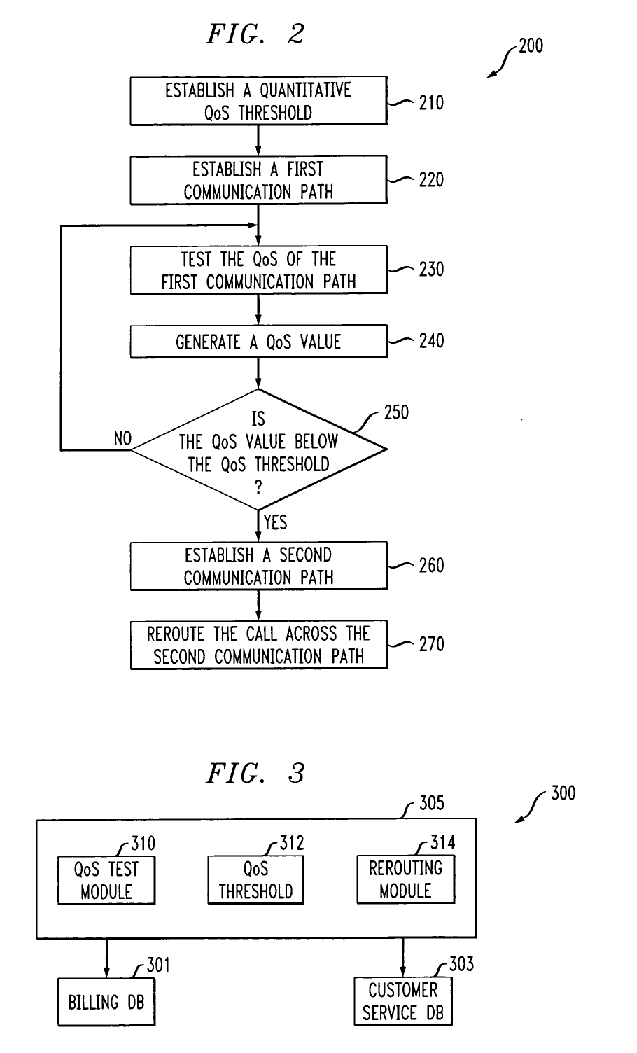

Referring now to FIG. 2, a method for rerouting a call based upon QoS is generally shown at 200. It should be understood that the method 200 may be implemented by a variety of software and hardware configurations. In one embodiment, the software implementing the method 200 in FIG. 3 resides on the switch 5. In this embodiment, the switch communicates to the network provider 21 that QoS on the call supported by the first communication path 7 is below the minimum acceptable standard. The call is then rerouted through the method 200 which is explained in further detail below.

The method 200 includes establishing a quantitative QoS threshold (at 210). This may be accomplished in a variety of manners known to those in the field. The quantitative QoS threshold will serve to determine what level of quality the network path will tolerate before setting up another communication path in which to carry the call. For example, if there is a demand for very high voice quality, the QoS threshold 312 (FIG. 3) may be set very high. If the user has a low demand for voice quality, the QoS threshold may be set very low.

Next, the method 200 includes establishing a first communication path (at 220). In this embodiment, the path is established through a VoIP line 7 connected to a VoIP telephone 27. However, the first communication path could progress through a variety of acceptable networks. The QoS in the first communications path is tested (at 230). This test can be accomplished using a variety of methods. For example, the test can be conducted using bong tone, audio logo, or a loop back method, as will be appreciated by those skilled in the art. Any suitable test may be conducted, provided that the test generates a value based on the QoS (at 240). In addition, many factors can affect the generated QoS value. For example, the VoIP line 7 quality may be greatly diminished because of excessive bandwidth usage. In addition, the VoIP line 7 quality may be diminished because the service provider has a tower down or the line providing the service has been cut. Finally, the switch 5 may receive the information from a variety of resources. For example, the switch 5 can conduct the test internally or it can get the information from a gateway 4 or CPE that conducted a test.

A determination is then made as to whether the QoS value is below the threshold level of acceptable quality (at 250). In one form, the switch 5 may test the quality of the connection during call setup, before the call is connected. In another form, the testing is conducted during the call. In yet another form, the testing is conducted continuously throughout the call. If the QoS value is at or above an acceptable value, the call is maintained. If the QoS value is below the minimum satisfactory level, then a second communication path is established (at 260).

In this case, the second communication path is established and the call re-routed thereon (at 270), while maintaining at least one termination point 3. This may include establishing a three port conference circuit between the first and second communication paths and disconnecting the first communication path when the second communication path becomes active. This second communication path may also be connected to a third termination point.

For example, in one form, a first communication path may be disposed between the first termination point 3 and the VoIP telephone 27 through the VolP line 7. In operation, referring back now to FIG. 1, for any of a number of reasons, the QoS value could fall below an acceptable standard. As a result, the switch 5 conducts a test (at 230) and would determine that the QoS value is below the QoS threshold (e.g. at 250). The service provider 21 would then establish a second communication path through the cellular line 13. The cellular telephone 29 would then ring. The end user could then answer the cellular telephone 29 and the switch 5 would then disconnect the first communication path. However, if the end users choose not to answer the cellular telephone 29, the call is maintained on the VoIP line 7.

It should be understood that an end user could have a plurality of associated lines. For example, if the end user declines to answer the cellular telephone 29, another communication path can be established connecting the POTS line 23 to the first termination point 3 through the PSTN 32, causing the POTS line telephone 31 to ring. Again, the end user would then answer the POTS line telephone 31 and the switch 5 would disconnect the first communication path 7. It should also be understood that more than one alternative communication path can be established simultaneously. In this system, for example, more than one telephone line would be connected and ring at the same time. The user would then have the option of answering any one of the lines or still continuing the call on the first communication path.

In another embodiment, the contemplated method includes testing the QoS of the second communication path. If the QoS value is not better on the second communication path, the call would not be rerouted. Another embodiment includes testing the availability of the third termination point 29. When the third termination point is a cellular telephone 29, this method could include contacting the mobile telephone switching office in order to locate the cellular phone 29, determining if the cellular phone 29 is near the current termination point 27, and determining if the cellular phone 29 is currently able to accept calls. If the third termination point is the POTS line 23, this method could include calling the line 23 in order to check its availability. The call would be maintained on the first communication path 7 as long as possible if there is no better alternative communication path.

The method 200 is especially useful with dual mode telephones, in particular when the third termination point is associated with the same device as the second termination point. For example, in one form, the VoIP telephone 27 is the same device as the cellular telephone 29. When this method is executed, the dual mode telephone 27, 29 could, for example, auto-answer the newly established call.

Referring now to FIG. 3, in one embodiment a switch 300, (or switches 5 as in FIG. 1) houses a testing module 310, a rerouting module 314, QoS threshold 312 and a connection to a billing database 301 and customer service 303. It should be appreciated that this is but one embodiment and the above features could be included in a gateway 4, a CPE, a plurality of other devices or any combination thereof.

The quantitative QoS threshold 312 will serve to determine the level of quality that the network path will tolerate before determining that there is a need to set up another communication path for the call. For example, if there is a demand for very high voice quality, the QoS threshold 312 may be set very high. If the user has a low demand for voice quality, the QoS threshold 312 may be set very low.

The testing module 310 is adapted to measure the QoS of the first path and to derive a quantitative value of the QoS. This can be accomplished by a variety of methods, which are known to those skilled in the art. For example, a testing module may be adapted to perform a loop back test from a quantitative score can be derived.

The rerouting module 314 is adapted to set up a second communication path if the quantitative value of the QoS of the first communication path is not meet the acceptable level of the QoS threshold 312.

The billing database 301 is where the billing information in stored. Customer service 303 is where the service provider 25 collects information about the network path in order to solve problems associated with the customer's service.

Another embodiment includes functionality to generate a report as to why the first communication 7 path was rerouted. This report may be generated through trouble shooting in order to find the cause of the low QoS. This can be accomplished through a variety of methods that are known to those skilled in the art.

Another embodiment includes sending this report to a billing database 301 and/or to a customer service database 301. In this respect, the service provider 25 could use the information in order to debug the system and improve the voice quality on the service. In addition, the service provider 25 may not bill the end user for use of additional minutes because the network made the decision to reroute the call.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method to reroute a data transmission having a first termination point and a second termination point based upon quality of service (QoS) comprising:
establishing a quantitative quality of service threshold;
establishing a first communication path through a network for the data transmission;
testing the quality of service of said first communication path during the data transmission or data transmission set up;
generating a quantitative value based upon said quality of service;
establishing at least a second communication path for the data transmission if said quantitative value is not up to the level of said quantitative quality of service threshold; and
rerouting the data transmission from said first communication path to said at least second communication path while maintaining at least said first termination point.

2. The method as set forth in claim 1 wherein the data transmission is a call.

3. The method as set forth in claim 1 further comprising rerouting said data transmission from said first communication path to said second communication path while said second communication path is in a different network than said first communication path.

4. The method as set forth in claim 1 further comprising rerouting said data transmission from said first communication path to said second communication path while said second communication path is utilizing a different transport type than said first communication path.

5. The method as set forth in claim 1 further comprising connecting said second communication path to a third termination point.

6. The method as set forth in claim 5, further comprising testing the availability of said third termination point.

7. The method as set forth in claim 5, further comprising displaying a special signal on a device associated with said third termination point.

8. The method as set forth in claim 1, further comprising testing the quality of service of said second communication path.

9. The method as set forth in claim 1, further comprising generating a report comprising the reasons for rerouting said first communication path.

10. The method as set forth in claim 8, further comprising sending said report to a telephone service provider.

11. The method as set forth in claim 1, further comprising communicating that said first communication path was rerouted to a billing database.

12. A system that enables a call to be rerouted comprising:
a quantitative quality of service threshold;
a quality of service test module adapted to measure the quality of service and derive a quantitative value for quality of service; and
a rerouting module adapted to set up at least a second communication path if said quantitative value for quality of service of a first communication path is not to the level of said quantitative quality of service threshold.

13. A system as set forth in claim 12 wherein said second communication path is in a different network than said first communication path.

14. A system as set forth in claim 12 wherein said second communication path is in a different transport type than said first communication path.

15. A system as set forth in claim 12 wherein said rerouting module and quality of service testing module are housed within a switch.

16. A system to reroute a call having a first termination point and a second termination point based upon quality of service (QoS) comprising:
a means for establishing a quantitative quality of service threshold;
a means for establishing a first communication path through a network for a call;
a means for testing the quality of service of said first communication path during the call or call set up;
a means for generating a quantitative value based upon said quality of service;
a means for establishing at least a second communication path for the call if said quantitative value is not up to the level of said quantitative quality of service threshold; and
a means for rerouting said call from said first communication path to said at least second communication path while maintaining at least said first termination point.

17. The system as set forth in claim 16 further comprising a means for rerouting said call from said first communication path to said second communication path while said second communication path is in a different network than said first communication path.

18. The system as set forth in claim 16 further comprising a means for rerouting said call from said first communication path to said second communication path while said second communication path is utilizing a different transport type than said first communication path.

19. The system as set forth in claim 16 further comprising a means for connecting said second communication path to a third termination point.

20. The system as set forth in claim 19, further comprising a means for testing the availability of said third termination point.

21. The method as set forth in claim 19, further comprising displaying a special signal on a device associated with said third termination point.
